(19) United States
(12) Patent Application Publication
(10) Pub. No.: US 2014/0306005 A1
(43) Pub. Date: Oct. 16, 2014

(54) Method for Data Transport and Recovery of Dependent Creatures

(71) Applicant: FOREVER YOURS, INC., Fort Wayne, IN (US)

(72) Inventor: Douglas Kline, Fort Wayne, IN (US)

(21) Appl. No.: 14/251,698

(22) Filed: Apr. 14, 2014

Related U.S. Application Data
(60) Provisional application No. 61/811,769, filed on Apr. 14, 2013.

(51) Int. Cl. G06F 17/30

(52) U.S. Cl. CPC G06F 17/30879
USPC 235/380

(57) ABSTRACT

A method for reuniting lost dependent creatures with a guardian, or, alternatively, to store and transport information pertaining to a dependent creature, where the dependent creature is equipped with a unique identification tag bearing a two-dimensional bar code scannable using smartphones and other equipment typically carried by many individuals and a scan of the unique identification tag provides information to the scanning individual about the dependent creature and substantially simultaneously provides information about at least the location of the scanning device to the guardian.

### CROSS-REFERENCE TO RELATED APPLICATIONS

This Application claims priority to and incorporates by reference in its entirety, U.S. Provisional Application No. 61/811,769, filed on Apr. 14, 2013.

### STATEMENT REGARDING FEDERALLY SPONSORED RESEARCH OR DEVELOPMENT

Not applicable

### BACKGROUND

Guardians of dependent living creatures, including but not limited to pets, children, domestic animals, livestock, or elderly or disabled adults, face a set of common problems. Dependent creatures can become misplaced or lost, and, once misplaced or lost, often lack the ability to clearly and accurately convey information necessary for their recovery and reunification with a guardian. Dependent creatures also often lack the ability to use communication devices such as phone or email, with the result that, when separated from a guardian, they are unable to communicate their status, ownership information, health information, or other relevant, information. Dependent creatures are further often unable to convey relevant information to third parties, including but not limited to conveying location information, conveying ownership information, conveying lineage information, or conveying medical information to medical care providers. This inability to convey important information results in inconvenience in many contexts. In the context of medical care, for example, the inability to transport or convey important information requires a dependent creature's guardian to transport and convey sometimes extensive medical information or records to doctors or veterinarians.

Several methods have been attempted to resolve some or all of these problems, however, none have succeeded entirely. When the dependent creature is a pet or domestic animal, for example, it is known to the art to use animal information tags with the pet's name and address written or engraved on the tag. The amount of information that can be legibly displayed by a typical pet tag is, however, limited and such tags do not directly apprise guardians of the whereabouts or status of their pets, or to convey information too voluminous to be displayed on the tag. The limited information contained on a typical tag is often insufficient to ensure reliable recovery of the pet. When the dependent creature is a human, bracelets and other jewelry have been used to serve a similar function to a pet tag. Such jewelry, however, suffers the same limitations in data quantity and data sufficiency as are suffered by a pet tag.

It is further known to the art to encode more extensive information about a dependent creature such as a pet or domestic animal within a microchip and then to implant the chip in the dependent creature. Such chips can also be used to locate the dependent creature. The implantation procedure is, however, expensive, inconvenient, and uncomfortable to the dependent creature. And, when the dependent creature is a human, many consider chip implantation undesirable for medical, aesthetic, or moral reasons. In another attempted solution, U.S. Pat. No. 7,578,433 discloses animal tags that utilize one-dimensional bar-codes to encode information about the animal. Such a tag does not resolve fully the problems known to the art, however, since the animal cannot be identified as the subject of the animal tag; and, more importantly, use of the tag depends on the finder possessing a personal digital assistant capable of reading one-dimensional bar codes. This makes it unlikely that a common person who finds an animal wearing such a tag will be able to access the information encoded in the bar code at the time of the find.

### SUMMARY

The present invention overcomes problems known to the art by providing a method for reuniting lost dependent creatures with a guardian using equipment typically carried by many individuals, while simultaneously automatically alerting the guardian that the lost dependent creature has been found. The present invention further overcomes problems known to the art by providing a method for storing and easily transporting large amounts of medical or other information pertaining to a dependent creature in a manner easily accessible to anyone given access to the dependent creature's information tag.

### BRIEF DESCRIPTION OF THE DRAWINGS

These and other features, aspects, and advantages of the present invention will become better understood with regard to the following description and accompanying drawings, where:

FIG. 1 shows an embodiment of an information tag that can be used in accordance with embodiments of the methods of the present invention

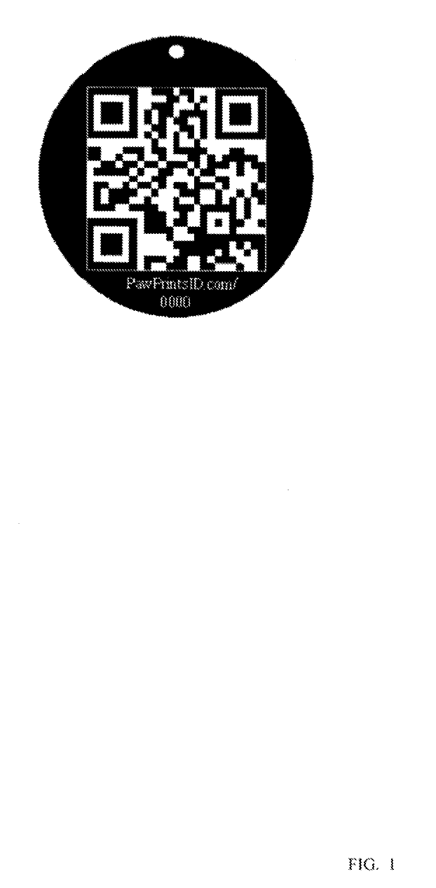

FIG. 2 shows a block diagram of the flow of information pertaining to a dependent creature according to one embodiment of the methods of the present invention

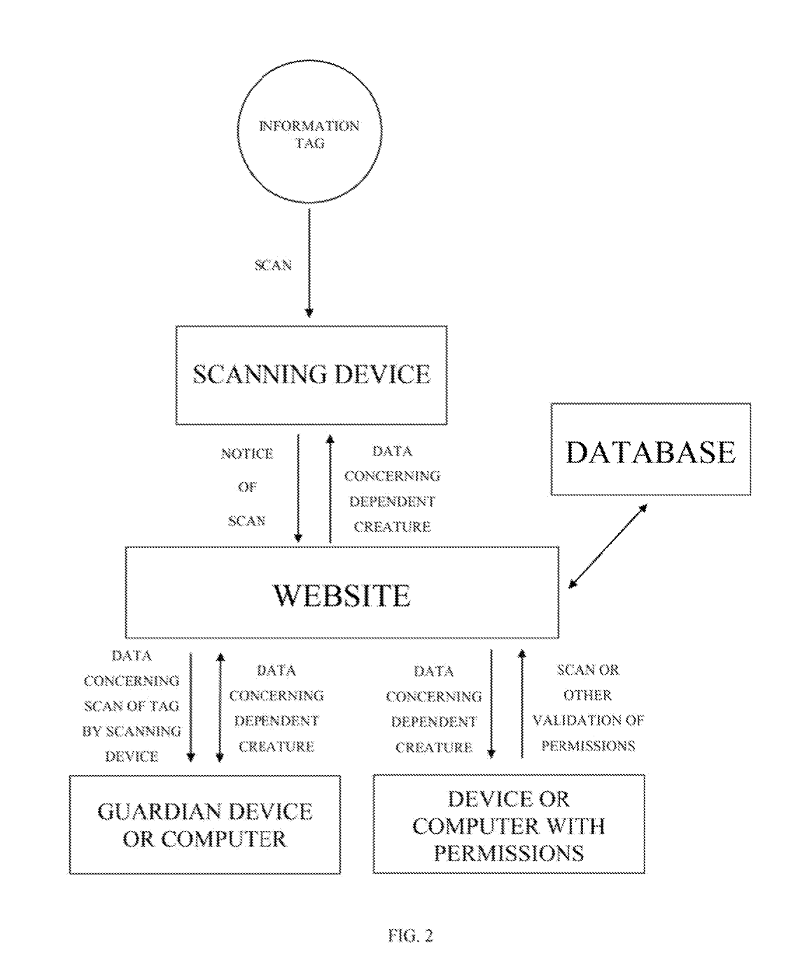

### DETAILED DESCRIPTION

A “dependent creature” according to versions of the present invention refers to any animal, person, or thing wearing or intended to wear an information tag within the scope of versions of the present invention. A dependent creature includes, but is not limited to a pet, domestic animal, livestock, child, disabled adult, or elderly individual. A dependent creature may optionally include a wild animal, a healthy adult, or an object.

An “information tag” according to versions of the present invention refers to a tag, badge, pin, or other object adapted to be worn by, carried by, or affixed to a dependent creature, that bears a scannable two-dimensional bar-code unique to that dependent creature. Preferably, the two-dimensional bar code is a QR code scannable by a variety of suitable handheld electronic devices. An information tag can be of any size or shape, however, an information tag is preferably sized and shaped to balance convenience of wear with ease of access for scanning of its two-dimensional bar code. An information tag according to versions of the present invention can be configured as, by way of non-limiting example, as necklace, is bracelet, is tab, a key ring, a buckle, is bangle, a clip, a pin, an ornament, a dog tag, a pet tag, a nametag, or an article of clothing. The two-dimensional bar code displayed by the information tag may be located anywhere on the information tag where it is accessible for scanning. For example, in an embodiment where the information tag is a bracelet, the two-dimensional bar code can be located on the outer surface of the bracelet, the inner surface of the bracelet, or a side of the bracelet. Alternately, the two-dimensional bar code could be located on a tag, tab, bangle, ornament, or other attachment to the bracelet. In a preferred embodiment, the information tag comprises a tab attached to a wearable neck band, wherein a QR code is displayed on one or both surfaces of the tab, and said QR code can be scanned or interrogated by a suitable handheld device. Scanning or interrogating said two-dimensional barcode and scanning or interrogating said information tag are used interchangeably herein, and both refer to scanning or interrogating said two-dimensional barcode.

“Device” or “devices,” as used herein, refers to handheld or stationary electronic devices adapted to scan or interrogate the two-dimensional bar code displayed on an information tag. Suitable devices include, but are not limited to camera-equipped cellular or “smart” phones, or any other device equipped to scan or interrogate a two-dimensional bar-code. It will be appreciated by one skilled in the art that camera-equipped handheld phones are commonly equipped to scan, decode, and receive instructions from, for example, QR codes. Preferably, the device is a camera-equipped smart phone capable of scanning or interrogating a QR code and then responsively accessing the website page or URL to which the QR code directs it.

Embodiments of methods of the present invention include the use of databases, data within those databases, and means of conveying data from those databases via website pages or URLs for display on devices. In preferred embodiments hereof, selected data concerning a dependent creature and, optionally, its guardian, is inputted for storage in a database. Data pertaining to a specific dependent creature is associated with a specific information tag registered or assigned to that dependent creature. Preferably, when an information tag is scanned or interrogated by a device, selected data associated with that information tag is displayed on one or more website pages or URLs, and the scanning or interrogating device is directed to said websites pages or URLs. Optionally, the data content of said website pages or URLs is persistent, and a device is directed to them upon scanning or interrogating an information tag. Alternately, the data content of said website pages or URLs is not persistent, and is generated for display in conjunction with the scanning or interrogating of the associated information tag.

In a preferred embodiment, selected data pertaining to a dependent creature is stored in a database. This data is associated with the information tag assigned or registered to that dependent creature. When the two-dimensional bar code displayed on that dependent creature's information tag is scanned or interrogated by a device, the scanning or interrogating device is instructed by the two-dimensional bar code to access a website or URL displaying selected data pertaining to the dependent creature. Optionally, the website or URL may also display data pertaining to the dependent creature's guardian. Preferably, said selected data is pre-selected by the guardian.

Preferably, when the two-dimensional bar code displayed on a dependent creature's information tag is scanned by a device, the dependent creature's guardian or other authorized representative is further provided with automatic electronic notice that the information tag was scanned or interrogated. Such electronic notice may be provided to one or more of the guardian, the guardian's agent or designee, a medical provider, police, social agencies, or other government or charitable organizations. Preferably, such electronic notice is provided to the guardian or their designee. Such electronic notice may be provided, for example, through email, text message, or telephone call, automatically generated upon the occurrence of scan or interrogation of the information tag by a device.

Most preferably, such electronic notice includes information concerning the location of the device that scanned or interrogated the dependent creature's information tag. It will be appreciated by one skilled in the art that when, by way of example, a camera-equipped smartphone scans or interrogates a QR code, the QR code can instruct the smartphone to provide approximate location data to a specified website or URL. In a preferred embodiment hereof, the two-dimensional bar code displayed on the information tag instructs a scanning or interrogating device to provide approximate location information for the device to a specified website or URL, and to further provide data adapted to associate said location information with the identity of the information tag scanned or interrogated. Said specified website or URL is preferably configured to, upon receipt of such location information, generate automatic electronic notice including such location information to parties associated with the dependent creature.

The data displayed to a scanning or interrogating party may be selected and determined by the guardian. Such data can include, but is not limited to, one or more of the dependent creature's photograph, name, address, telephone number, email address; guardian's name, guardian's address, guardian's telephone number, guardian's email address; secondary contact name, secondary contact address, secondary contact telephone number, secondary contact email address; dependent creature's medical provider's name, medical provider's address, medical provider's telephone number, medical provider's email address; dependent creature's medications, medical conditions, medical records, medical history, allergies, habits, preferences, gender, breed, likes, dislikes; or other special instructions or conditions.

Versions of the present invention may provide selected access to data pertaining to a single information tag, with the selected data displayed to a specific device dependent upon permissions granted to that device. It will be appreciated by one skilled in the art that a website page or URL can be programmed to collect identifying information from a scanning or interrogating device, to determine what permissions, if any have been granted to that device, and to display data commensurate with the permissions granted to that device. As will be appreciated by one skilled in the art, the website page or URL that determines the permissions granted to a scanning or interrogating device need not be the same website page or URL displaying data. It will be further appreciated to one skilled in the art that such permissions can be granted to a device by providing the device with a specific URL, username, or passcode to register or authorize the device as having specified permissions.

In one optional embodiment, when an information tag is scanned or interrogated by a device without any permissions, the device is directed to a website page or URL displaying only data suitable to reunite a dependent creature with its guardian. Such information may include the dependent creature's photograph, dependent creature's name, guardian's name, or guardian's contact information. Preferably, the guardian is substantially simultaneously provided electronic notice that the information tag was scanned or interrogated, including the information pertaining to the approximate location of the scanning or interrogating device. Optionally, this same information tag may be simultaneously associated with other data in the database including more extensive or more private information, wherein only scanning or interrogating devices with specific permissions are directed to URLs or websites displaying such more extensive or more private information.

In one embodiment hereof, such more extensive or more private information may include the dependent creature's medical information, including medical history, medication, and medical records. In one embodiment herein, when the dependent creature's information tag is scanned or interrogated by a device without permissions to view such more extensive or more private information, the device is directed to a URL or website displaying only information suitable to reunite the dependent creature with its guardian and, optionally, the guardian is provided simultaneously provided notification that the information tag was scanned or interrogated, including the location of the scanning or interrogating device. When said information tag is scanned or interrogated by a device with permissions to view such more extensive or more private information, the device is directed to a website or URL displaying the more extensive or more private information. In a preferred embodiment hereof, the device possessing permissions to view such more extensive or more private information is registered to or associated with the dependent creature's medical provider, and such more extensive or more private information includes said dependent creature's medical records, medical history, and medications.

Embodiments of the present invention are directed towards methods of reuniting a lost dependent creature with its guardian. In general, these embodiments of the present invention comprise the following steps: (1) entering information pertaining to the dependent creature into a database, wherein said data is selectively displayable via a website page or URL; (2) equipping a dependent creature with an information tag displaying a two-dimensional barcode unique to that dependent creature; (3) associating that dependent creature's data within the database with the information tag such that devices that scan or interrogate the information tag are directed to website pages or URLs displaying selected data pertaining to that dependent creature or its guardian; (4) a device scans or interrogates the information tag; (5) the scanning or interrogating device is directed to one or more website pages or URLs displaying selected data suitable to assist with reuniting the dependent creature with its guardian and, optionally; (6) substantially simultaneously with the scanning or interrogating of the information tag by the device, one or more of the guardian, guardian's designee, medical provider, police, social agency, or other government or charitable official receives electronic notice that the information tag has been scanned via one or more of email, text message, or telephone call.

Embodiments of the present invention are further directed to methods of transporting and displaying specific data pertaining to a dependent creature. In general, these embodiments comprise the following steps: (1) entering data pertaining to the dependent creature into a database, wherein said data is selectively displayable via a website page or URL; (2) equipping a dependent creature with an information tag displaying a two-dimensional barcode unique to that dependent creature; (3) associating data within the database pertaining to said dependent creature with the dependent creature's information tag such that devices that scan or interrogate said information tag are directed to one or more website pages or URLs displaying selected data pertaining to that dependent creature or its guardian; (4) a device scans or interrogates the information tag (5) the scanning or interrogating device is directed to one or more website pages or URLs; and (6) website pages or URLs displaying selected data pertaining to the dependent creature or its guardian are displayed. Optionally, (7) said one or more website pages or URLs first determines the permissions of said scanning or interrogating device; and (8) said websites or URLs displaying selected data commensurate with the permissions of the scanning or interrogating device.

Optionally, websites or URLs displaying data pertaining to a dependent creature may be accessed without using a device to scan or interrogate an information tag. An information tag may optionally further comprise as unique visual identifier. Unique identifiers include, but are not limited to, unique URLs, passcodes, passwords, or user IDs that can be entered into an internet browser and which are adapted to direct said internet browser to a website or URL displaying selected data from the database pertaining to the dependent creature or its guardian. In these embodiments of the invention, a user enters said unique identifier into a computer terminal. The computer terminal then displays selected data pertaining to said dependent creature or its guardian.

Although the present invention has been described in considerable detail with reference to certain preferred versions thereof, other versions are possible. For example, other categories of data, methods of web access, or methods of data display may be used within the scope and spirit of this invention. Additionally, the steps of the methods disclosed herein may be performed in any order. Therefore, the spirit and scope of the foregoing should not be limited to the description of the preferred versions described herein.

What is claimed is:

1. A method of reuniting a dependent creature with its guardian, said method comprising the steps of:
(a) entering data pertaining to the dependent creature into a database, wherein said data is selectively displayable via a website page or URL;
(b) equipping a dependent creature with an information tag displaying a unique two-dimensional barcode;
(c) associating data within the database pertaining to said dependent creature with the dependent creature's information tag such that devices that scan or interrogate said two-dimensional barcode are directed to one or more website pages or URLs displaying selected data pertaining to said dependent creature or its guardian;
(d) a device scans or interrogates said two-dimensional barcode;
(e) said device is directed to said one or more website pages or URLs displaying selected data pertaining to said dependent creature or its guardian.

2. The method of claim 1, wherein said information tag comprises a wearable tag.

3. The method of claim 2, wherein said two-dimensional barcode is a QR code.

4. The method of claim 3, wherein said selected data displayed by said website pages or URLs includes one or more of said dependent creature's photograph, dependent creature's name, dependent creature's address, dependent creature's telephone number, dependent creature's email address; guardian's name, guardian's address, guardian's telephone number, guardian's email address; secondary contact name, secondary contact address, secondary contact telephone number, secondary contact email address; dependent creature's breed, gender, likes, or dislikes; or other special instructions or conditions.

5. The method of claim 4, wherein the method further comprises the step of:
(a) substantially simultaneously with the scanning or interrogating of the two-dimensional barcode by a device, electronic notice that the information tag has been scanned is provided via one or more of email, text message, or telephone call to one or more of the guardian, guardian's designee, medical provider, police, social agency, or other government or charitable official.

6. The method of claim 5, wherein said electronic notice further includes information pertaining to the approximate location of the scanning or interrogating device.

7. The method of claim 6, wherein the dependent creature is one or more of a pet, domestic animal, livestock, child, or elderly person.

8. A method for transporting and displaying data pertaining to a dependent creature, said method comprising the steps of:
(a) entering data pertaining to the dependent creature into a database, wherein said data is selectively displayable via a website page or URL;
(b) equipping a dependent creature with an information tag displaying a unique two-dimensional barcode;
(c) associating data within the database pertaining to said dependent creature with the dependent creature's information tag such that devices that scan or interrogate said two-dimensional barcode are directed to one or more website pages or URLs displaying selected data pertaining to said dependent creature or its guardian;
(d) a device scans or interrogates said two-dimensional barcode;
(e) the scanning or interrogating device is directed to one or more website pages or URLs; and
(f) said website pages or URLs display selected data pertaining to the dependent creature or its guardian.

9. The method of claim 8, wherein said information tag comprises a wearable tag.

10. The method of claim 9, wherein said two-dimensional barcode is a QR code.

11. The method of claim 10, further comprising the steps of:
(a) after said two-dimensional barcode is scanned or interrogated, said scanning or interrogating device is directed to a website or URL that determines the permissions possessed by said scanning or interrogating device;
(b) said scanning or interrogating device is directed to one or more website pages or URLs displaying only selected data for which said scanning or interrogating device has permissions.

12. The method of claim 11, wherein a device registered or assigned to a medical provider for said dependent creature has permissions to view medical information pertaining to said dependent creature, said medical information including one or more of dependent creature's photograph, dependent creature's name, dependent creature's address, dependent creature's telephone number, dependent creature's email address; guardian's name, guardian's address, guardian's telephone number, guardian's email address; secondary contact name, secondary contact address, secondary contact telephone number, secondary contact email address; dependent creature's medications, medical conditions, medical records, medical history; dependent creature's allergies, habits, preferences, gender, breed, likes, dislikes; or other special instructions or conditions.

13. The method of claim 12 further comprising the step:
(a) of said scanning or interrogating device does not have any permissions, selected data displayed by said website pages or URLs is pre-determined by said guardian and includes only one or more of said dependent creature's photograph, dependent creature's name, dependent creature's address, dependent creature's telephone number, dependent creature's email address; guardian's name, guardian's address, guardian's telephone number, guardian's email address; secondary contact name, secondary contact address, secondary contact telephone number, secondary contact email address; dependent creature's breed, gender, likes, or dislikes; or other special instructions or conditions.

14. The method of claim 13, wherein the method further comprises the step of:
(a) substantially simultaneously with the scanning or interrogating of the two-dimensional barcode by a device, electronic notice that the information tag has been scanned is provided via one or more of email, text message, or telephone call to one or more of the guardian, guardian's designee, medical provider, police, social agency, or other government or charitable official.

15. The method of claim 14, wherein said electronic notice further includes information pertaining to the approximate location of the scanning or interrogating device.

16. The method of claim 15, wherein the dependent creature is one or more of a pet, child, domestic animal, livestock, or elderly person.

17. A method for transporting and displaying data pertaining to a dependent creature, said method comprising the steps of:
(a) entering data pertaining to the dependent creature into a database, wherein said data is selectively displayable via a website page or URL;
(b) equipping a dependent creature with an information tag displaying as unique identifier;
(c) associating selected data within the database pertaining to said dependent creature or its guardian with said unique identifier;
(d) said unique identifier is inputted into an internet browser;
(e) said internet browser is directed to one or more website pages or URLs displaying selected data pertaining to said dependent creature.

18. The method of claim 17, wherein said selected data comprises one or more of dependent creature's photograph, dependent creature's name, dependent creature's address, dependent creature's telephone number, dependent creature's email address; guardian's name, guardian's address, guardian's telephone number, guardian's email address; secondary contact name, secondary contact address, secondary contact telephone number, secondary contact email address; dependent creature's medications, medical conditions, medical records, medical history; dependent creature's allergies, habits, preferences, gender, breed, likes, dislikes; or other special instructions or conditions.

19. The method of claim 18, wherein the method further comprises the step of:
(a) substantially simultaneously with entry of said unique identifier into an internet browser, electronic notice that unique identifier has been entered is provided via one or more of email, text message, or telephone call to one or more of the guardian, guardian's designee, medical provider, police, social agency, or other government or charitable official.

20. The method of claim 19, wherein said electronic notice further includes one or more of the IP address associated with the computer terminal or device on which said internet browser is run; or the approximate location of said computer terminal or device on which said internet browser is run.

21. The method of claim 21, wherein said dependent creature is one or more of pet, child, domestic animal, livestock, or elderly person.
